(19) United States
(12) Patent Application Publication
(10) Pub. No.: US 2001/0006293 A1
(43) Pub. Date: Jul. 5, 2001

(54) Push-bar for doors in general

(75) Inventor: Hans Rupp, Tschierv (CH)

Correspondence Address: GREER, BURNS & CRAIN, LTD., 300 South Wacker Drive - 25th floor, Chicago, IL, 60606, US

(73) Assignee: Storo Tschierv GmbH

(21) Appl. No.: 09/748,987

(22) Filed: Dec. 27, 2000

(30) Foreign Application Priority Data
Dec. 31, 1999 (IT) MI99A002767

(51) Int. Cl. E05B 3/00

(52) U.S. Cl. 292/336.3

(57) ABSTRACT

A push-bar for doors in general, comprising a bar-like element which is adapted to be applied to one side of a door by means of a pair of couplings; one of the couplings, arranged at an edge of the door that is adapted to abut against the doorjamb, being provided with lever means which are adapted to actuate a latch element which protrudes from the coupling of the bar-like element and is adapted to abut against the doorjamb.

### BACKGROUND OF THE INVENTION

The present invention relates to a push-bar for doors in general. More particularly, the invention relates to a push-bar for safety doors and the like. The invention further relates to a reversible lock which can be associated with a push-bar.

It is known that bars which allow rapid opening of an emergency door without the need to turn any bar are provided for doors in general and more particularly for safety doors and the like.

Such bars have in fact a transverse longitudinal member which, when impacted by pressure applied by a person's body, allows the emergency door to open without the person having to use his hands to open said door.

Various bars for emergency doors and the like are known which, as mentioned, are constituted by a transverse longitudinal member which can be connected to the door in various manners. In particular, a type of bar is known which cantilevers out from the door to which it is fixed but has the drawback of being considerably thick and of being aesthetically unsightly.

In general, any type of bar, however, entails that the actual lock is accommodated inside the structure of the door, so that the latch of the lock protrudes from the thickness of the frame of said door.

Although this solution is widely used, it nonetheless entails the drawback of having to provide doors with compartments preset to accommodate the lock and most of all of having to determine from the start the direction in which said door will open.

If the door opens to the left, the lock must in fact be located in a certain position, which does not coincide with the position that it must assume when the door opens to the right.

Reversibility of the opening of a door is a highly important requirement for present-day doors, and the need to predefine the door opening direction causes problems at the manufacturing level.

The door manufacturer must in fact provide two different door types, one for leftward opening and one for rightward opening, consequently increasing manufacturing costs.

### SUMMARY OF THE INVENTION

The aim of the present invention is to provide a push-bar for doors in general in which the door to which the bar is connected needs no compartments for accommodating the lock.

Within this aim, an object of the present invention is to provide a push-bar for doors in general in which the particular configuration of the bar allows to provide a single door type both for leftward opening and for rightward opening.

Another object of the present invention is to provide a push-bar for doors in general whose installation is highly simplified with respect to conventional bars.

Another object of the present invention is to provide a lock which can be associated with a door to which said bar is applied and is of the reversible type.

Another object of the present invention is to provide a lock which can be associated with a door to which the bar is applied and allows to open the door from the outer side, which lies opposite with respect to the bar application side, and in any case does not prevent the opening of the door from the bar side even when the lock is closed.

Another object of the present invention is to provide a push-bar for doors in general which is highly reliable, relatively simple to manufacture and at competitive costs.

This aim and these and other objects which will become better apparent hereinafter are achieved by a push-bar for doors in general, comprising a bar-like element which is adapted to be applied to one side of a door by means of a pair of couplings, characterized in that one of said couplings, arranged an the edge of said door that is adapted to abut against a doorjamb, is provided with lever means which are adapted to actuate a latch element which protrudes from said coupling of the bar-like element and is adapted to abut against said doorjamb.

### BRIEF DESCRIPTION OF THE DRAWINGS

Further characteristics and advantages of the present invention will become better apparent from the following detailed description of a preferred embodiment of the push-bar according to the invention, illustrated only by way of non-limitative example in the accompanying drawings, wherein:

FIG. 1 is a perspective view of a portion of a door to which the push-bar according to the invention is applied;

FIG. 2 is a perspective view of the coupling of the push-bar according to the invention, from the side on which the door abuts against the doorjamb during closure;

FIG. 3 is a sectional top plan view of the coupling of the push-bar of FIG. 2, in the condition in which the door is open;

FIG. 4 is a sectional top plan view of the coupling of the push-bar of FIG. 2 in the condition in which the door is closed;

FIG. 5 is a front view of the coupling of the push-bar of FIG. 2 in a condition in which the door is closed;

FIG. 6 is a partially sectional front view of the coupling of the push-bar in a condition in which the door is closed, showing in dashed lines the door opening condition that can be provided by pushing against the push-bar from the inside;

FIG. 7 is a sectional front view of the coupling of the push-bar in a door closure condition, showing in dashed lines the door opening condition that can be achieved from the side that lies opposite the one to which the push-bar is applied, by means of the external opening handle;

FIG. 8 is an exploded view of a handle-type reversible lock which can be associated with the push-bar shown in FIGS. 1 to 7;

FIG. 9 is a partially sectional plan view of the handle-type lock of FIG. 8 in a counterclockwise opening condition; and

FIG. 10 is a partially sectional plan view of the handle-type lock of FIG. 8 in a clockwise opening condition.

### DESCRIPTION OF THE PREFERRED EMBODIMENTS

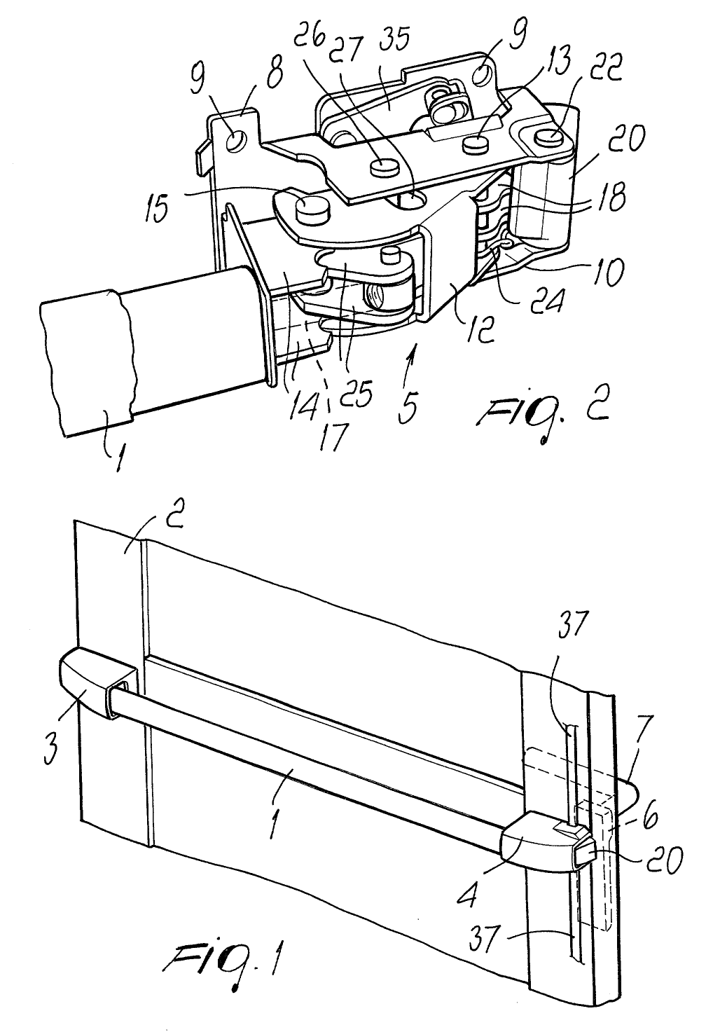

With reference to the figures, and initially to FIG. 1, the push-bar according to the invention, designated by the reference numeral 1, is applied to a door 2 by means of a pair of lateral couplings 3 and 4, in which the reference numerals 3 and 4 actually designate the elements that protect said couplings.

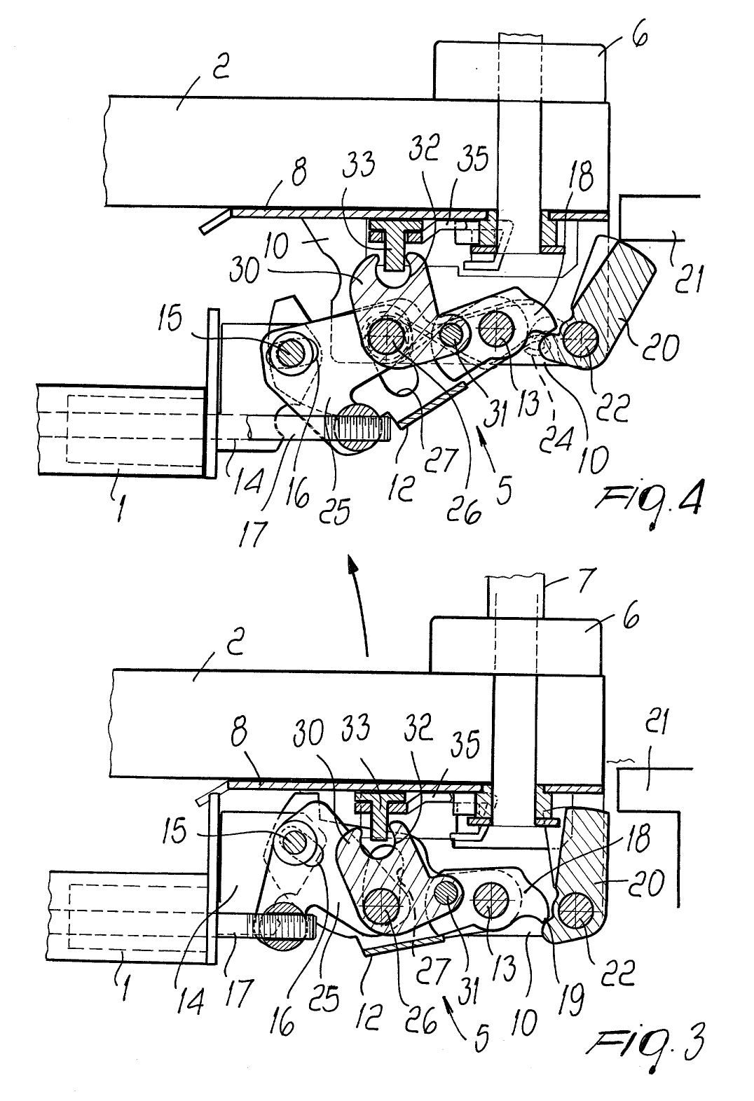

The left coupling in FIGS. 1 and 3 is of a conventional type, while the right coupling is designated by the reference numeral 5 in FIG. 2 and is shown in detail in the subsequent figures.

FIG. 1 is a view of a lock 6, with corresponding handle 7, at the opposite side of the door 2.

The particularity of the invention consists of the fact that the lock of the door 2 is contained entirely, as regards opening from the push-bar side, within the covering element 4 of the push-bar 1 and is substantially provided by the coupling 5 shown in FIG. 2.

The remaining part of the lock, for opening the door 2 from the outside, is contained in the lock 6 with a handle 7 applied at the surface of the door 2 that lies opposite the one to which the push-bar 1 is applied.

In practice, this allows to avoid the need for the door 2 to have a compartment for accommodating the lock, since the lock is applied externally to the door frame 2.

In detail, as shown in FIGS. 2 to 7, the coupling 5 of the push-bar 1 comprises a plate-like element 8 which is adapted to be applied to the door frame 2, so as to allow to fix the push-bar 1 to said door. Conveniently, the plate-like element 8 is provided with holes 9 for fixing to the door frame.

The plate-like element 8 is provided with two lateral shoulders 10 which are adapted to contain a mechanism for moving the door so as to open/close it by operating the push-bar 1.

First lever means 12 are pivoted to the shoulders 10 by means of a first pivot 13, and the push-bar 1 is directly pivoted to means 12 by way of a pair of shoulders 14 thereof which protrude from the push-bar 1. In practice, the pivoting of the shoulders 14 to the first lever means 12 is provided by means of a second pivot 15 which is accommodated in a slot 16.

Second lever means 18 are pivoted inside the first lever means by way of the same first pivot 13 cited earlier and are provided with a hook-shaped end portion 19 which allows the engagement of the second lever means 18 with a latch element 20 which, in a position which protrudes from the frame of the door 2, as shown in FIG. 4, is meant to abut against the doorjamb 21 and thus prevent the opening of the door.

Conveniently, the latch element 20 is pivoted to the pair of shoulders 10 by means of a third pivot 22.

Conveniently, the second lever means 18 are pushed downward by the first lever means 12 as a consequence of the actuation of the push-bar 1.

Elastic return means, conveniently formed for example by a spring 24, are provided in order to keep the latch element 20 in the closed position and allow said latch element to retract into the position shown in FIG. 3 only following an actuation of the push-bar 1.

Third lever means 25 are pivoted to the first lever means 12 by way of the pivot 15 and are pivoted, at the opposite end, to the first lever means 12 by means of a fourth pivot 26 which can move freely in a slot 27 formed in the first lever means 12.

A threaded rod 17 is further pivoted to the third lever means and by passing longitudinally within the push-bar 1 it allows, when the push-bar 1 is pressed, to actuate the push-bar opening mechanism.

Conveniently, the threaded rod 17 that is connected to the third lever means 25 allows, once it is pressed by pressing on the push-bar 1, to move the third lever means 25, which in turn transmit the motion to the first lever means 12, which compress the second lever means 18 with consequent retraction of the latch element 20, which accordingly moves into the active position shown in FIG. 3.

Accordingly, the first, second and third lever means cooperate in order to allow the opening of the latch element 20, and its subsequent return to the active position is determined by the presence of the spring 24, which passes around the pivot 26 and with one portion under the pivot 13, while the other portion of the spring passes above the second lever means 18.

Conveniently, there are fourth lever means 30 which are pivoted to the third lever means 25, and accordingly to the first lever means 12, by way of the fourth pivot 26 and to the second lever means 18 by way of a fifth pivot 31. The fourth lever means 30 are conveniently shaped so as to have, at the end that is meant to be directed toward the plate-like element 8, an open circular seat 32 which allows engagement with a pivot-like element 33 which is arranged at right angles to the plate-like element 8 and is free to perform a translatory motion, as described in detail hereinafter.

The pivot-like element 33 allows the pivoting of a pair of arms 35 which are arranged so that one of said arms is on either side of the shoulders 10.

The arms 35 have engagement elements 36 for respective rod-like elements 37, which are adapted to perform a translatory motion parallel to the surface of the door and transversely to the push-bar 1.

Conveniently, the actuation of the push-bar 1 by pushing from the inward side of the door 2 allows, as mentioned, to move the latch element 20 into a retracted position and therefore allows to open the door 2 from inside even if the external lock is turned into the closure position.

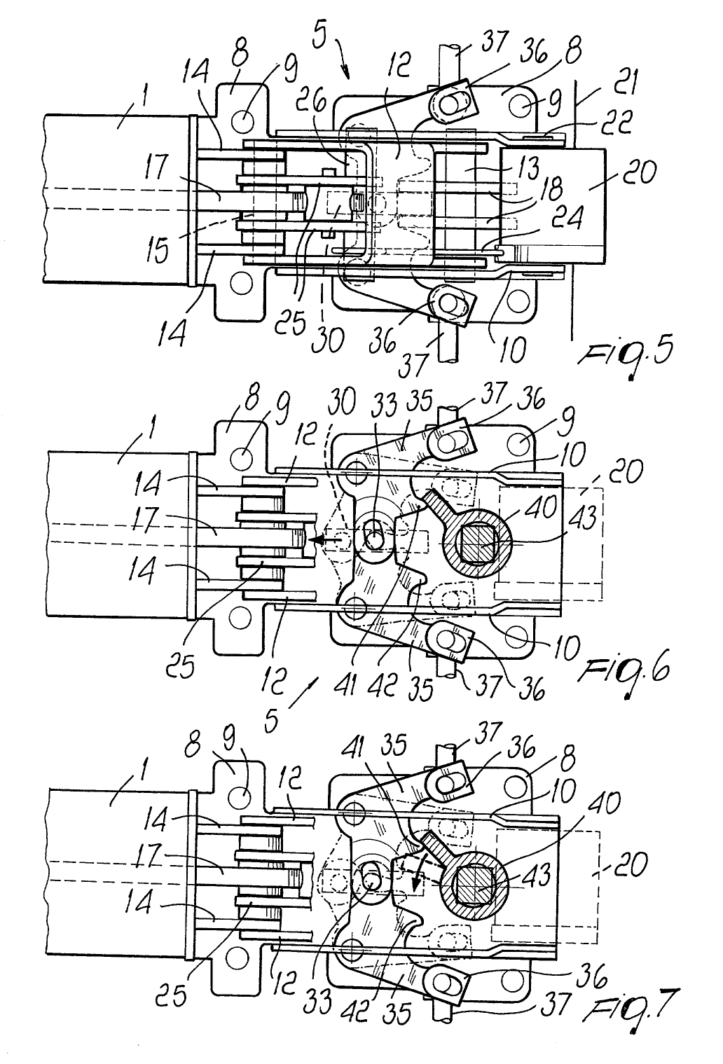

FIGS. 5, 6 and 7 illustrate in detail the operation of the push-bar according to the invention in its two operating modes.

In particular, FIG. 6 illustrates the case in which the door is opened from the inside, i.e., from the side on which the push-bar 1 is applied.

In this condition, when the latch element 20 is in the closure position, the pressure applied by a person to the push-bar 1 causes the push-bar to move into the position shown in FIG. 3, with a consequent movement of the first, second, third and fourth lever means 12, 18, 25 and 30.

The fourth lever means 30 engage the pivot 33 by means of the cavity 32 and perform a translatory motion, to the left in the drawing, of the pivot 33; accordingly, the arms 35 close internally, simultaneously with the action applied by the second lever means 18, which push the latch element 20 upward, so as to turn it into a retracting position, as shown in FIG. 3.

In this manner, by way of the action of the push-bar 1 alone, it is possible to release both the latch element 20 and any rod-like elements 37 that are connected to the arms 35, thus allowing to open the door 2.

In this condition, shown in FIG. 6, the abutment element 40, actuated by the handle 7 of the lock 6 arranged on the opposite side of the door with respect to the side to which the push-bar 1 is applied, has no function, and even if it is in the closure position, as shown in FIG. 6, the retraction of the arms 35 causes it to remain disengaged from said arms.

In particular, it should be noted that the abutment element 40 can rotate in order to abut against a protruding portion 41 of one of the arms 35 or, on the opposite side, against a protruding portion 42 of the opposite arm.

This allows to obtain reversibility of the lock.

The abutment element 40 is actuated by a square pivot 43 which is operated by the handle 7 of the lock 6.

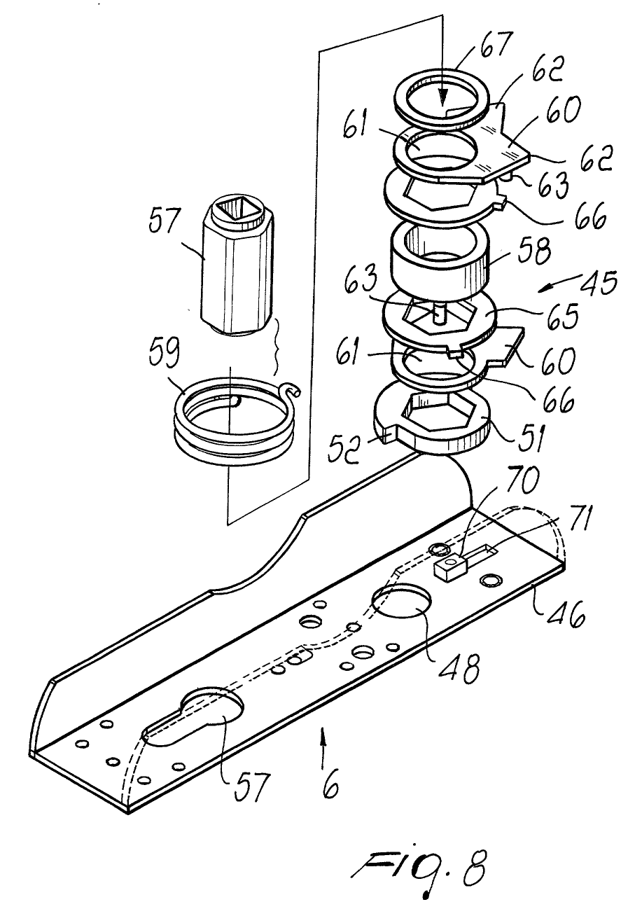

FIG. 7 instead illustrates the condition in which the door 2 is opened from outside, i.e., from the opposite side with respect to the one to which the push-bar 1 is applied, by using the handle 7. In this condition, the handle 7 turns, by means of the square pivot 43, the abutment element 40, which as shown by the arrow of FIG. 7 pushes against the protruding portion 41 of the arm 35, inducing a retraction and closure movement of the arms 35, and consequently causing a backward movement of the pivot 33, with the same upward thrust action applied by the second lever means 18 to the latch element 20, which returns into the position shown in FIG. 3.

Also in this second case, therefore, the door 2 can be opened easily.

FIG. 8 is an exploded view of the latch 6, which can be associated with the push-bar 1 by applying it to the door 2 at the opposite side with respect to the one to which the push-bar 1 is applied.

The lock 6 is of the reversible type, i.e., it allows doors to open from left to right and from right to left.

This is achieved by way of a particular configuration of the opening mechanism, which is generally designated by the reference numeral 45.

In detail, the lock 6 comprises a substantially U-shaped body 46 which has an opening 47 for the insertion of the cylinder of the key, not shown, and a second opening 48 which allows the engagement of the handle 7 in order to turn the opening mechanism 45.

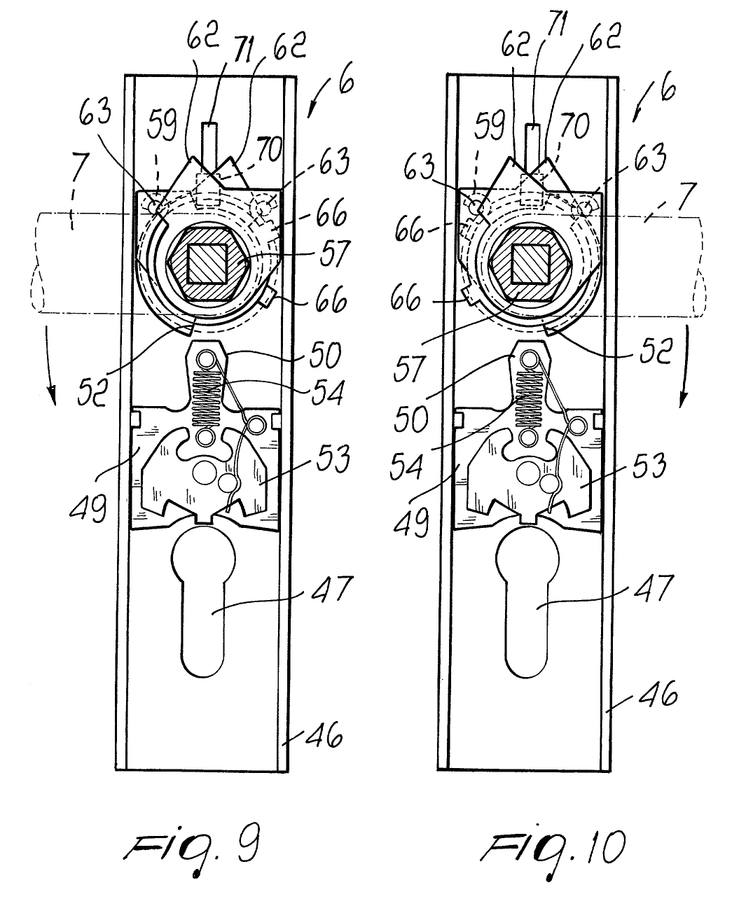

In detail, as shown in FIG. 9 and in FIG. 10, the body 46 of the lock has a plate-like element 49 which is provided with a protruding end 50 which is designed to abut against the opening mechanism 45 of the lock 6 and in particular against a first base element 51 which is shaped so as to have a semicircular portion, is internally hollow and has a hexagonal hole; its purpose is described in detail hereinafter.

The plate-like element 49 is pushed elastically upward by the movement of the key in the cylinder of the lock (not shown), which causes the plate-like element 49 to be pushed upward when the key is turned for closure, engaging the protruding portion 50 with a recess 52 formed in the first element 51, which has two symmetrical recesses 52 so as to allow reversibility of the lock 6.

In practice, the rotation of the key of cylinder of the lock acts on a second plate-like element 53, which is elastically rigidly coupled to the plate-like element 49, by means of a spring 54, and said second plate-like element 53 disengages the first plate-like element 50, which accordingly can move.

The opening mechanism 45 comprises a plurality of substantially annular elements which are stacked on each other around a pivot 57 which has a hexagonal external cross-section and a square internal cross-section.

In detail, the mechanism 45 comprises, symmetrically with respect to a spacer element 58 around which a spring 59 is arranged whose function and exact arrangement will be described hereinafter, a first abutment element 60 which is provided with a circular central hole 61 and therefore does not rotate when the hexagonal pivot 57 rotates.

The abutment element 60 is provided with two wings 62 which are arranged symmetrically with respect to the center of the hole 61. Each one of the two abutment elements 60 is provided with a protruding pivot 63, and the two pivots 63 of the two abutment elements 60 are arranged so as to be directed toward each other but not in a mirror-symmetrical arrangement.

The pivots 63 allow to engage the two ends of the spring 59.

A disk-like element 65 is provided between the abutment elements 60 and the spacer element 58, for each side, has a hexagonal central hole and is thus turned by the rotation of the pivot 57, which is peripherally provided with a tooth 66 which alternately engages one of the two pivots 63, as described in detail hereinafter.

Finally, an annular element 67 is provided on top of the above-described elements which compose the opening mechanism 45 and acts as an element for supporting the opening mechanism 45 against the surface of the door 2.

The reversibility of the lock 6 is ensured by the circular shape of the element 51 and by the fact that there is a slider element 70 which can move in a slot 71. The position of the slider element 70 shown in FIG. 8 and the position shown in FIGS. 9 and 10 is a position for locking the element 51, since the slider element 70 engages in one of the recesses 52 of the element 51, while the other recess 52 is engaged, in the lock closure position, by the protruding portion 50 of the plate-like element 49.

When one wishes to change the direction in which the door opens, the slider element 70 is made to slide along the slot 71 and the element 51 can be turned so as to change the recess 50 that will abut against the slider element 70. These two conditions are shown in FIGS. 9 and 10, in which FIG. 9 relates to the case in which the door opens to the left, while FIG. 10 relates to the case in which the door opens to the right.

As clearly shown, the element 51 is arranged to the left in one figure and to the right in the other figure.

The two abutment elements 60, with the corresponding pivots 63 to which the spring 59 is engaged, allow to preload the spring when the handle 7 is turned downward, abutting against the walls of the body 46, as shown in FIG. 9 and in FIG. 10.

The two disk-like elements 65, with the respective teeth 66, are instead arranged so that their teeth are mutually offset, so that when the door opens in one direction one of the teeth 66 abuts against one of the pivots 63, allowing to load the spring 59, while the other tooth 66 is disengaged, as shown in FIG. 9.

When the reversibility of the lock is used, the situation is reversed and the tooth 66 that was disengaged now engages the pivot 63 that lies opposite with respect to the pivot that abutted against the other tooth 66.

Substantially, when switching from opening in one direction to opening in the opposite direction, the teeth 66 swap their roles and so do the pivots 63.

In practice it has been observed that the push-bar according to the invention fully achieves the intended aim and objects, since it can be applied easily to the surface of a door, with the lock contained in one of the couplings of the push-bar, thus avoiding the need to provide adequate seats in the thickness of the door in order to accommodate the lock.

Likewise, the lock that can be associated with the push-bar, applied on the opposite side of the door to which the push-bar is applied, allows reversibility by way of the particular configuration of the opening mechanism.

The push-bar thus conceived is susceptible of numerous modifications and variations, all of which are within the scope of the inventive concept; all the details may furthermore be replaced with other technically equivalent elements.

In practice, the materials employed, so long as they are compatible with the specific use, as well as the dimensions, may be any according to requirements and to the state of the art.

The disclosures in Italian Patent Application No. MI99A002767 from which this application claims priority are incorporated herein by reference.

What is claimed is:

1. A push-bar for doors in general, comprising a bar-like element which is adapted to be applied to one side of a door by means of a pair of couplings, wherein one of said couplings, arranged at an edge of said door that is adapted to abut against a doorjamb, is provided with lever means which are adapted to actuate a latch element which protrudes from said coupling of the bar-like element and is adapted to abut against said doorjamb.

2. The push-bar according to claim 1, wherein said coupling comprises a plate-like element which is provided with two lateral shoulders which are adapted to contain said lever means which are pivoted to said lateral shoulders.

3. The push-bar according to claim 2, wherein said lever means comprise first lever means which are pivoted to said pair of lateral shoulders and to said bar-like element, second lever means which are pivoted to said first lever means and are adapted to abut against said latch element, in order to disengage said latch element from said doorjamb.

4. The push-bar according to claim 3, wherein said lever means comprise third lever means which are pivoted to said bar-like element and to said first lever means.

5. The push-bar according to claim 4, wherein said first lever means are provided with a slot in which a pivot engages for the pivoting of said third lever means to said first lever means.

6. The push-bar according to claim 3, wherein said first lever means are adapted to push downward against said second lever means, said second lever means engaging said latch element, in order to produce a movement for the disengagement of said latch element from said doorjamb.

7. The push-bar according to claim 4, comprising elastic return means which are coupled between said pivot for the pivoting of said third lever means to said first lever means and a pivot for the pivoting of said second lever means to said first lever means.

8. The push-bar according to claim 4, comprising fourth lever means which are pivoted to said third lever means and to said first lever means and to said second lever means, said fourth lever means being provided with a portion which is shaped so as to form an engagement seat for a pivot which protrudes from said plate-like element of said coupling.

9. The push-bar according to claim 2, comprising two arms which are connected to said pivot which protrudes from said plate-like element and are adapted to move from an open position, in which said arms protrude from said plate-like element of said coupling, to a closure position, in which said arms retract into the shoulders of said plate-like element of the coupling of the push-bar.

10. The push-bar according to claim 9, comprising an abutment element which can be actuated by means of a lock arranged on an opposite side of is the door with respect to the one where said push-bar is applied, said abutment element being adapted to engage a cusp-shaped portion of one of said arms.

11. The push-bar according to claim 8, wherein the actuation of said fourth lever means in engagement with said pivot which protrudes from said plate-like element of the coupling of the push-bar produces a closure movement of said arms together with a retraction movement of said latch element, so as to allow the opening of said door, the engagement of said fourth lever means with said pivot which protrudes from the plate-like element being induced by a thrust applied to said bar-like element at right angles to a surface of said door to which said bar-like element is applied.

12. The push-bar according to claim 9, wherein said arms pivoted to said pivot which protrudes from said plate-like element are further pivoted to said plate-like element.

13. The push-bar according to claim 9, wherein two rod-like elements are respectively connected to said arms and are adapted to constitute additional elements for the closure of said door, in addition to said latch element, said rod-like elements being arranged substantially at right angles to a longitudinal extension of said bar-like element and parallel to the edge of said door that is meant to abut against said doorjamb.

14. A reversible lock, comprising a substantially U-shaped body;
a mechanism for opening a door to which said body is meant to be connected;
means for locking/releasing said opening mechanism of said door;
further comprising adjustment means for adjusting the direction of rotation of a handle which is adapted to be applied to said lock, said adjustment means comprising an abutment slider element which can move along a slot and is adapted to pass from a position for engagement with said lock opening mechanism to a disengagement position which allows an intended positioning of at least one element of said opening mechanism.

15. The lock according to claim 14, wherein said at least one element of said opening mechanism is an annular element provided with a portion which protrudes with respect to a remaining portion of said annular element and is shaped like a circular arc.

16. The lock according to claim 15, wherein said opening mechanism further comprises a first abutment element and a second abutment element which are adapted to abut against walls of said body, and a first element and a second element for loading elastic means which are arranged around a spacer element and are engaged with said first and second abutment elements.

17. The lock according to claim 16, wherein said opening mechanism further comprises a central pivot which has a hexagonal cross-section and around which said at least one element of the opening mechanism, said first and second abutment elements, said spacer element and said first and second elements for loading said elastic means are inserted.

18. The lock according to claim 17, wherein said first and second abutment elements are provided with a circular central hole and are adapted to remain in the predefined position following a rotation of the handle of said lock.

19. The lock according to claim 18, wherein said pivot has a square internal cross-section.

20. The lock according to claim 19, wherein said first and second elements for loading said elastic means comprise at least one tooth which is adapted to abut against a respective pivot of the abutment element that is arranged adjacent to said first and second loading elements.

21. The lock according to claim 20, wherein said elastic means are respectively engaged by means of their ends to the pivots of said first and second abutment elements, said first and second elements for loading said elastic means being provided with a central hole which has a hexagonal cross-section and being adapted to turn as a consequence of the rotation of is said pivot actuated by the handle of said lock.

22. The lock according to claim 21, wherein said spacer element is provided with a circular central hole.
